(19) United States
(12) Patent Application Publication
(10) Pub. No.: US 2006/0269100 A1
(43) Pub. Date: Nov. 30, 2006

(54) Composite marker and composite marker information acquisition apparatus

(75) Inventors: Akito Saito, Hino-shi (JP); Akira Shirai, Hino-shi (JP)

Correspondence Address: Scully, Scott, Murphy & Presser, 400 Garden City Plaza, Garden City, NY, 11530-3319, US

(73) Assignee: Olympus Corporation, Tokyo (JP)

(21) Appl. No.: 11/500,629

(22) Filed: Aug. 8, 2006

Related U.S. Application Data
(63) Continuation of application No. PCT/JP05/19222, filed on Oct. 19, 2005.

(30) Foreign Application Priority Data
Dec. 17, 2004 (JP) 2004-366181
Dec. 17, 2004 (JP) 2004-366182
Dec. 17, 2004 (JP) 2004-366183
Dec. 17, 2004 (JP) 2004-366184
Mar. 25, 2005 (JP) 2005-089509

(51) Int. Cl. G06K 9/00

(52) U.S. Cl. 382/100

(57) ABSTRACT

A composite marker includes an optical marker section having at least three feature points obtained by one of symbol and design containing a character which can optically be distinguished, the 3D arrangement of the feature points being known. The composite marker further includes a storage section configured to store location information of the optical marker section by which the area where the optical marker section is located can be specified, and a transmission section configured to transmit the location information of the optical marker section stored in the storage section in a non-contacting manner. The optical marker section, storage section, and transmission section are formed integrally.

### CROSS REFERENCE TO RELATED APPLICATIONS

This is a Continuation Application of PCT Application No. PCT/JP2005/019222, filed Oct. 19, 2005, which was published under PCT Article 21(2) in Japanese.

This application is based upon and claims the benefit of priority from prior Japanese Patent Applications No. 2004-366181, filed Dec. 17, 2004;

No. 2004-366182, filed Dec. 17, 2004;

No. 2004-366183, filed Dec. 17, 2004;

No. 2004-366184, filed Dec. 17, 2004; and

No. 2005-089509, filed Mar. 25, 2005, the entire contents of all of which are incorporated herein by reference.

### BACKGROUND OF THE-INVENTION

1. Field of the Invention

The present invention relates to a composite marker used in a system that uses a marker to present information and a composite marker information acquisition apparatus for acquiring information from the composite marker.

2. Description of the Related Art

Barcode readers have been widely known as an information presentation apparatus that presents predetermined information related to a real world object and/or a given marker.

Among them, there is an apparatus that uses the space information of an object and/or a given marker to present information. For example, U.S. Pat. No. 6,389,182 B1 discloses an information presentation apparatus that reads a 2D code printed on a business card using a camera, analyzes an ID corresponding to the 2D code using a program installed on a computer, and presents a photograph of a person corresponding to the ID on a display of the computer as if the photograph were printed beside the 2D code.

In more detail, the above apparatus disclosed in U.S. Pat. No. 6,389,182 B1 is an information presentation apparatus that inputs an image for a given marker and analyzes spatial localization information of the marker to recognize a corresponding ID to thereby output predetermined information related to the marker. The marker and predetermined information correspond to each other on a one-to-one basis. Accordingly, it is necessary to prepare ten different kinds of markers in order to present ten different kinds of information.

### BRIEF SUMMARY OF THE INVENTION

According to a first aspect of the present invention, there is provided a composite marker including an optical marker section having at least three feature points obtained by one of symbol and design containing a character which can optically be distinguished, the 3D arrangement of the feature points being known, comprising:

a storage section configured to store location information of the optical marker section by which the area where the optical marker section is located can be specified; and

a transmission section configured to transmit the location information of the optical marker section stored in the storage section in a non-contacting manner,

the optical marker section, storage section, and transmission section being formed integrally.

According to a second aspect of the present invention, there is provided a composite marker including an optical marker section having at least three feature points obtained by one of symbol and design containing a character which can optically be distinguished, the 3D arrangement of the feature points being known, comprising:

a storage section configured to store specific information of the optical marker section by which each composite marker can be specified among a plurality of composite markers having the optical marker sections with the same feature points; and

a transmission section configured to transmit the specific information of the optical marker section stored in the storage section in a non-contacting manner,

the optical marker section, storage section, and transmission section being formed integrally.

According to a third aspect of the present invention, there is provided a composite marker which is targeted by an information acquisition apparatus including a camera having a predetermined capturing area, and a non-contact ID information acquisition section which acquires information retained by a non-contact ID tag set in a predetermined position relative to the capturing area, the composite marker comprising:

an optical maker section having at least three feature points obtained by one of symbol and design containing a character which can optically be distinguished, the 3D arrangement of the feature points being known, and the position and posture of which relative to the camera that captures an image including the feature points thereof can be specified based on the captured image; and

a non-contact ID tag including a storage section configured to retain information related to one of the optical marker section and an article to which the optical marker section is fixed and a transmission section configured to transmit information retained by the storage section in a non-contacting manner,
the transmission section including an antenna section fixed to a predetermined position relative to the optical marker section.

According to a fourth aspect of the present invention, there is provided a composite marker information acquisition apparatus comprising:

an image capture section having a predetermined capturing area and configured to capture a marker which has an optical feature and which is fixed to an object located within the capturing area;

an information acquisition section configured to acquire information related to one of the marker and object fixed to the marker from a non-contact ID tag whose position is fixed relative to the marker and which retains the information related to one of the marker and object; and

an information acquisition control section configured to allow the information acquisition section to perform information acquisition based on an image captured by the image capture section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is front views of the front and back surfaces of a composite marker according to a first embodiment of the present invention;

FIG. 2 is a view showing a configuration of an information presentation apparatus serving as a composite marker information acquisition apparatus according to the first embodiment of the present invention;

FIG. 3A is a view showing that an information acquisition area which is an information area that can receive information from the non-contact ID tag completely encompasses the capturing area of a camera of an image input section;

FIG. 3B is a view showing that the capturing area and information acquisition area correspond to each other;

FIG. 3C is a view showing that the capturing area completely encompass the information acquisition area;

FIG. 3D is a view showing that the capturing area encompasses a part of the information acquisition section;

FIG. 4 is an operation flowchart of the information presentation apparatus according to the first embodiment of the present invention;

FIG. 5A is a view showing an article disposed in a real space;

FIG. 5B is a view showing related information stored in a related information storage section;

FIG. 5C is a view showing a display example;

FIG. 6 is a view showing a configuration of an information presentation apparatus serving as a composite marker information acquisition apparatus according to a second embodiment of the present invention;

FIG. 7 is an operation flowchart of the information presentation apparatus according to the second embodiment of the present invention;

FIG. 8 is an operation flowchart of the information presentation apparatus serving as the composite marker information acquisition apparatus according to a third embodiment of the present invention;

FIG. 9 is front views of the front and back surfaces of the composite marker according to a fourth embodiment of the present invention;

FIG. 10A is a view showing a state where two arrows, which are used as a symbol for indicating a known offset position or direction of the antenna, are displayed on the display screen of the display section in a superimposed manner at the marker detection time;

FIG. 10B is a view showing a state where two arrows, which are used as a symbol for indicating a known offset position or direction of the antenna, are displayed on the display screen of the display section in a superimposed manner at the marker detection time;

FIG. 10C is a view showing a state where a dashed circle, which is used as a symbol for indicating the position of the antenna, is displayed on the display screen of the display section in a superimposed manner;

FIG. 11 is front views of the front and back surfaces of the composite marker according to a fifth embodiment of the present invention; and

FIG. 12 is front views of the front and back surfaces of the composite marker according to a modification of the fifth embodiment of the present invention.

### DETAILED DESCRIPTION OF THE INVENTION

Preferred embodiments of the present invention will be described below with reference to the accompanying drawings.

### First Embodiment

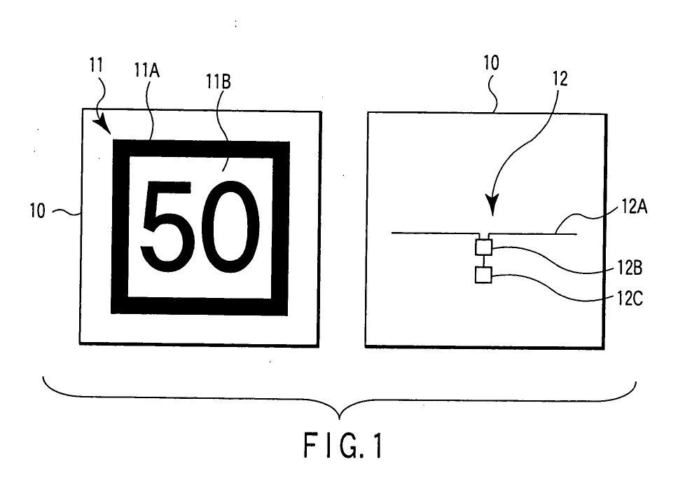

As shown in FIG. 1, a composite marker 10 according to a first embodiment of the present invention is formed by integrating a marker 11 which is a symbol containing coded information and a non-contact ID tag 12.

The marker 11 is disposed on the front surface of the composite marker 10. The marker 11 is constituted by a frame 11A having a predetermined shape and a symbol or design 11B containing characters within the frame 11A. That is, the marker 11 has three or more feature points which can be optically distinguished, and the 3D arrangement of the feature points needs to be known. With this configuration, a composite marker information acquisition apparatus can specify the position and posture of the marker 11 relative to a camera that captures the image based on the captured image including the feature points.

The non-contact ID tag 12 is disposed on the marker back surface (or inside the marker). In the first embodiment, the non-contact ID tag 12 is configured as an RFID tag including an antenna 12A having functions of receiving electrical power and transmitting/receiving data, an IC chip 12B incorporating electronic elements, and a storage section 12C for storing information. Although the IC chip 12B and storage section 12C are independently formed in FIG. 1, they may be formed on a single chip. Further, although FIG. 1 shows an example in which the IC chip 12B and storage section 12C have a rectangular shape and a dipole antenna is connected, as the antenna 12A, to the IC chip 12B, the shapes of the IC chip 12B, storage section 12C and antenna 12A may appropriately be changed.

In the RFID tag which is the non-contact ID tag 12, the IC chip 12B including a transmission/reception circuit receives external data transmitted on a carrier wave via the antenna 12A and uses the carrier wave to generate required electrical power. The IC chip 12B uses the electrical power to perform data reading/writing for the storage section 12C and data transmission using the antenna 12A so as to transmit information to an external device.

The storage section 12C previously stores information related to the marker 11 or information related to an article fixed to the composite marker 10 having the marker 11. In the present invention, the term “fixed” not only includes “directly fixed (to an article or the like)” but also includes “indirectly fixed”. That is, it encompasses a case where the composite marker 10 is disposed at a state where a predetermined position and posture relationship relative to an article is maintained. Information to be stored in the storage section 12C includes information related to the area in which the composite marker 10 is located. For example, in the case where the composite markers 10 are located in a five-story building (entire area), the entire area is divided into a plurality of segmented areas (e.g., by the number of floors) and information (i.e., the number of floors) different for each segmented area is written in the storage section 12C as area information. In this case, a plurality of the same symbol or design 11B e.g., markers representing “50” may exist between the segmented areas.

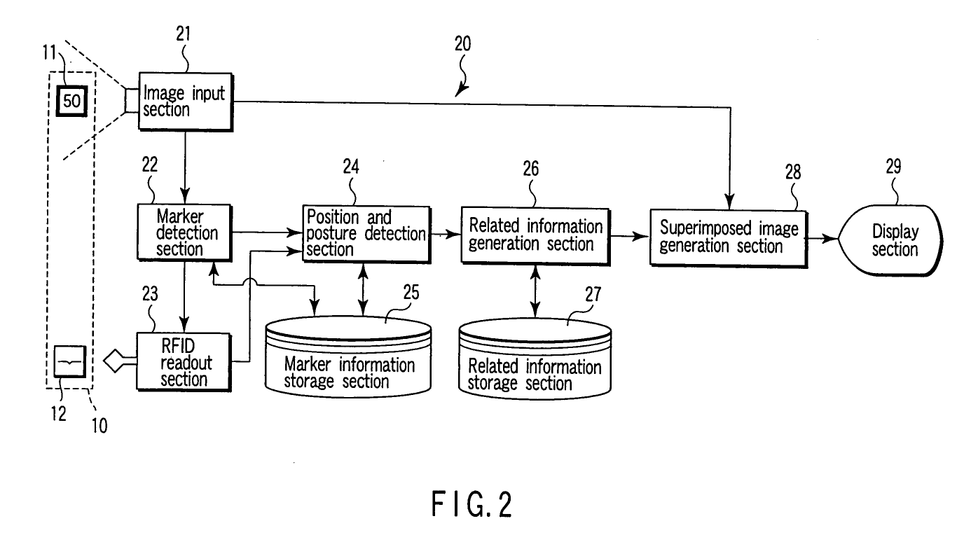

An information presentation apparatus 20 serving as a composite marker information acquisition apparatus according to the first embodiment of the present invention, which uses the abovementioned composite marker 10, includes an image input section 21, a marker detection section 22, an RFID readout section 23, a position and posture detection section 24, a marker information storage section 25, a related information generation section 26, a related information storage section 27, a superimposed image generation section 28, and a display section 29, as shown in FIG. 2. The information presentation apparatus 20 is configured as a mobile terminal such as a PDA with camera or a mobile phone with camera. In this case, all the components may be provided in the mobile terminal, or a part of the components may be located on a server that can be accessed by the mobile terminal via a network. However, the mobile terminal needs to be provided with at least the image input section 21, RFID readout section 23, and display section 29.

The image input section 21 uses a camera having a given capturing area to capture the composite marker 10 directly or indirectly fixed to an object (article). The image obtained by the imaging operation is input to the marker detection section 22. The marker detection section 22 detects the marker 11 of the composite marker 10 included in the image from the image input section 21 and supplies a result of the detection to the REID readout section 23 and position and posture detection section 24.

Upon receiving the marker detection result from the marker detection section 22, the RFID readout section 23 reads out information from the non-contact ID tag 12 which is an RFID tag of the composite marker 10. More specifically, the RFID readout section 23 transmits a data readout instruction on a carrier wave. Upon this instruction, the non-contact ID tag 12 transmits information to the RFID readout section 23. The RFID readout section 23 receives the information and supplies it to the position and posture detection section 24.

As described above, in the first embodiment, only when an information acquisition area (information area that can receive information from the non-contact ID tag 12) exists within the capturing area of the camera of the image input section 21, the RFID readout section 23 performs the above information readout operation. This suppresses power consumption of a battery (not shown) in the information presentation apparatus 20.

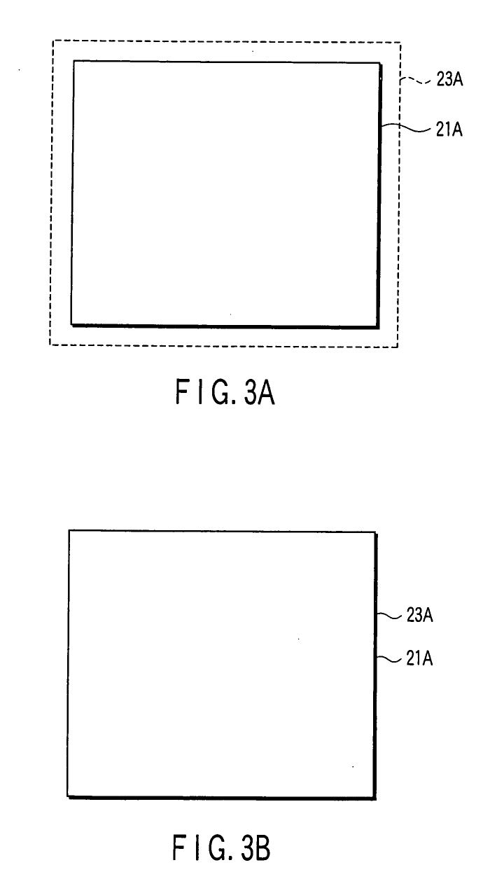

As shown in FIGS. 3A to 3D, it is only necessary that at least a part of an information acquisition area 23A exists in a capturing area 21A of the camera. However, as shown in FIGS. 3A and 3B, when the capturing area 21A completely encompasses the information acquisition area 23A, the information can be received more reliably. Accordingly, in the first embodiment, the marker detection section 22 detects the marker 11 and, based on the detection result, the RFID readout section 23 starts reading the information at the time when the marker 11 enters the capturing area 21A of the camera, that is, when it is estimated that the camera has reached a predetermined position and posture relative to the marker 11. The predetermined position and posture of the camera are generally set to a position and posture assumed when the camera fully faces the marker 11, i.e., the antenna 12A of the non-contact ID tag 12.

The position and posture detection section 24 uses the information included in the non-contact ID tag 12, which is input from the RFID readout section 23, and marker information input from the marker detection section 22 to identify a corresponding marker from information stored in the marker information storage section 25. After that, the position and posture detection section 24 utilizes a known technique such as described in U.S. Pat. No. 6,724,930 B1, U.S. Pat. No. 6,577,249 B1, or the like to detect the position and posture of the camera of the image input section 21 relative to the marker and supplies a result of the detection to the related information generation section 26. The marker information storage section 25 stores information related to the marker, such as a template image of the marker, area information indicating the area to which the marker belongs, and position and posture information of the marker.

The related information generation section 26 extracts previously set information from the related information storage section 27 according to the position and posture of the camera of the image input section 21 and identification result supplied from the position and posture detection section 24 to generate related information and supplies it to the superimposed image generation section 28. The related information storage section 27 stores information, such as position and posture information, shape information, and attribute information of a model set on a model space.

The superimposed image generation section 28 superimposes the related information generated by the related information generation section 26 on the image from the image input section 21 and supplies the obtained image to the display section 29. The display section 29 displays the superimposed image generated by the superimposed image generation section 28.

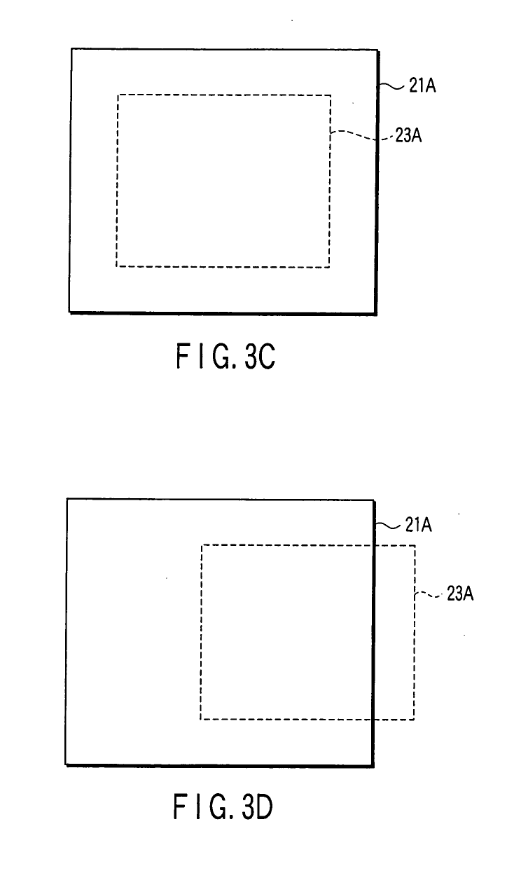

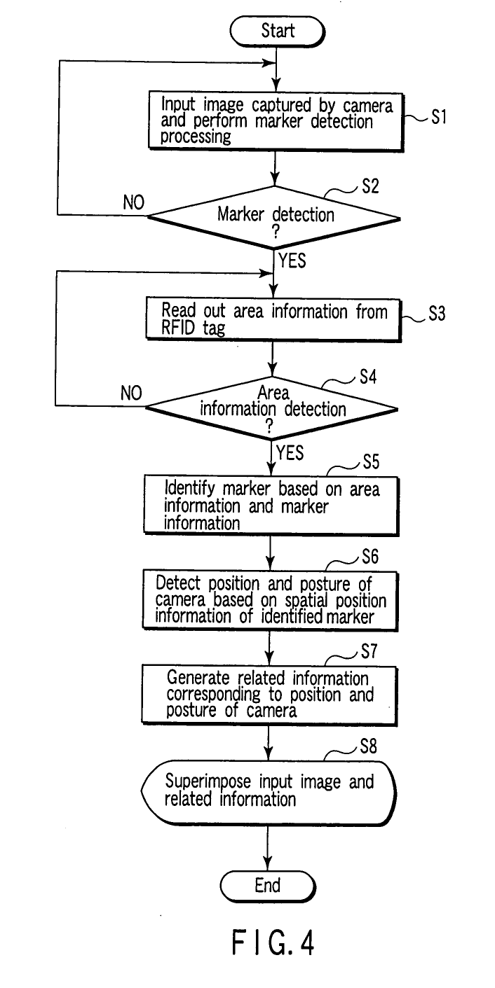

According to the flowchart shown in FIG. 4, the information presentation apparatus 20 having the configuration described above firstly uses a camera of the image input section 21 to capture an article 30 to which the composite marker 10 is fixed as shown in FIG. 5A and inputs the captured image to the marker detection section 22 to thereby detect the marker 11 (step S1). The marker detection section 22 firstly detects, from the captured image, the predetermined shape (in the case of the first embodiment, the rectangular frame 11A) of the marker 11 disposed on the front surface of the composite marker 10. A method for detecting the rectangular frame is a known image processing method, and the description thereof is omitted here. The marker detection section 22 then detects the coordinates of the four corners of the detected frame 11A (rectangular frame) within the entire image, extracts the area within the rectangular frame, and applies affine transformation to the extracted area. After that, the marker detection section 22 performs pattern matching between the image obtained after the affine transformation and template images of marker previously registered in the marker information storage section 25 to identify the marker 11. In the example of FIG. 5A, the marker detection section 22 identifies the symbol or design 11B as a marker of “50”. At this time point, however, it is impossible to specify the area that this marker of “50” indicates due to absence of area information. When the image obtained after the affine transformation does not match any of the template images of marker, the marker detection section 22 does not perform detection processing (step S2), and the flow returns to step S1.

After the marker 11 has been detected, the RFID readout section 23 reads out area information from the non-contact ID tag 12 (step S3). This operation starts when the RFID readout section 23 transmits a data readout instruction on a carrier wave. More specifically, the non-contact ID tag 12 uses a carrier wave received by the antenna 12A to generate required electrical power and, using the generated electrical power, the IC chip 12B reads out information stored in the storage section 12C and transmits the information by means of the antenna 12A. The RFID readout section 23 receives the information transmitted from the non-contact ID tag 12 and determines whether the received information is area information or not (step S4). When the received information is not area information, the flow returns to step S3 where the RFID readout section 23 reads out information from the non-contact ID tag 12 once again. On the other hand, when the received information is area information (e.g., area information indicating “area 1”), the flow advances to the subsequent step.

The position and posture detection section 24 identifies (as a marker of “50” of “area 1”) the composite marker 10 captured by the camera of the image input section 21 based on the marker information (marker of “50”) detected by the marker detection section 22 and area information (“area 1”) detected by the RFID readout section 23 (step S5).

After the identification of the marker has been achieved as described above, it is possible to acquire corresponding spatial position information (position and posture information of the marker) from the marker information storage section 25. This enables the position and posture detection section 24 to detect the position and posture of the camera of the image input section 21 from the coordinates of the four corners of the marker 11 within the image (step S6). The related information generation section 26 then extracts information corresponding to the marker identified by the position and posture detection section 24 from the related information storage section 27 and, based on the extracted information, generates related information corresponding to the position and posture of the camera detected by the position and posture detection section 24 (step S7).

As shown in FIG. 5B, as to the marker of “50” of “area 1”, the related information storage section 27 stores, as predetermined information, a 3D model 27A corresponding to the article 30 and annotation information (“CAUTION HOT”) 27B located below the composite marker 10 within the model space of the 3D model 27A. The related information generation section 26 generates related information in which the position and posture of the predetermined information (3D model 27A and annotation information 27B) correspond to those of the camera detected by the position and posture detection section 24.

The superimposed image generation section 28 then superimposes the image from the image input section 21 and related information generated by the related information generation section 26 and, as shown in FIG. 5C, displays the superimposed image on a display screen 29A of the display section 29 (step S8).

When the area information and marker information of the composite marker 10 are detected and position and posture of the camera is detected as described above, the superimposed image is displayed on the display screen 29A.

### Second Embodiment

A second embodiment of the present invention shows a case where an area ID is stored in the RFID tag which is the non-contact ID tag 12. That is, not the area information itself described in the first embodiment, but the ID corresponding to the area is stored in the storage section 12C of the non-contact ID tag 12 in the second embodiment.

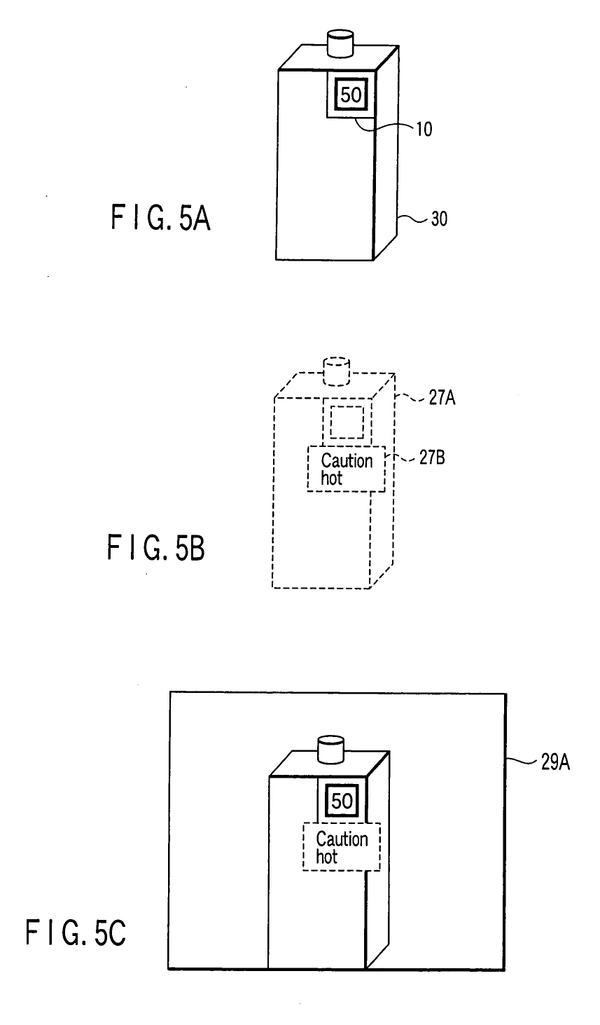

The information presentation apparatus 20 serving as a composite marker information acquisition apparatus according to the second embodiment of the present invention includes an area information storage section 40 which stores area information corresponding to the area ID, as shown in FIG. 6. The RFID readout section 23 extracts, from the area information storage section 40, the area information corresponding to the area ID read out from the non-contact tag 12.

The non-contact ID tag 12 may store a unique ID (in this case, the area information storage section 40 retains a table to which the unique ID has been registered) or spatial position information (latitude and longitude, etc.) of the marker.

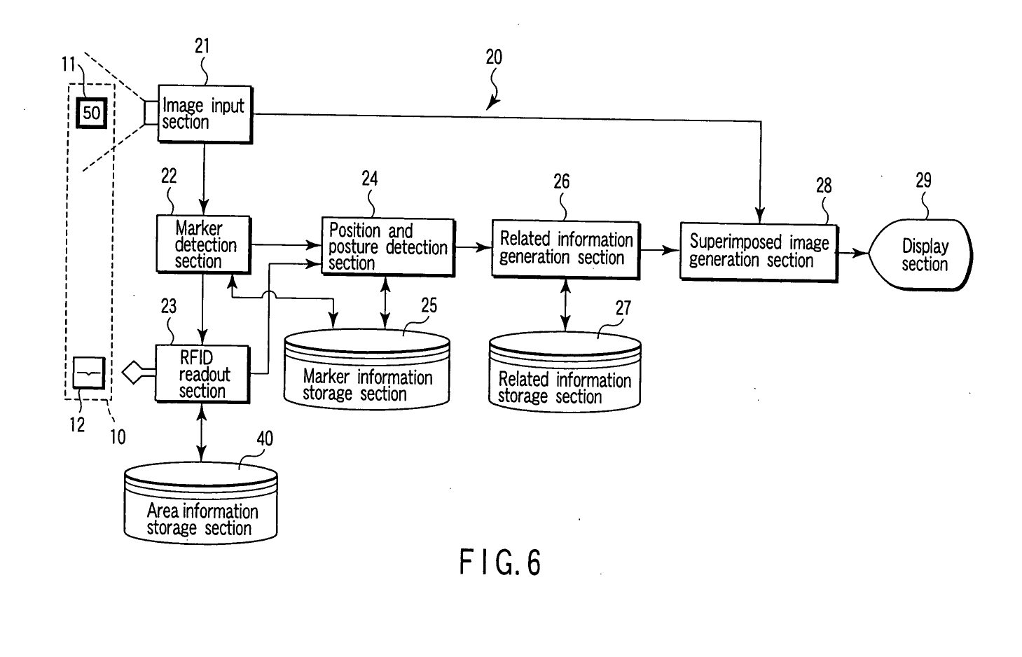

According to the flowchart shown in FIG. 7, the information presentation apparatus 20 according to the second embodiment firstly uses a camera of the image input section 21 to capture an article 30 to which the composite marker 10 is fixed and inputs the captured image to the marker detection section 22 to thereby detect the marker 11 (step S1), as in the case of the first embodiment.

After the marker 11 has been detected (step S2), the RFID readout section 23 reads out ID information from the non-contact ID tag 12 (step S11). This operation starts when the RFID readout section 23 transmits a data readout instruction on a carrier wave. More specifically, the non-contact ID tag 12 uses a carrier wave received by the antenna 12A to generate required electrical power and, using the generated electrical power, the IC chip 12B reads out information stored in the storage section 12C and transmits the information by means of the antenna 12A. The RFID readout section 23 receives the information transmitted from the non-contact ID tag 12 and determines whether the received information is ID information (area ID) or not (step S12). When the received information is not ID information, the flow returns to step S11 where the RFID readout section 23 reads out information from the non-contact ID tag 12 once again. On the other hand, when the received information is ID information, the RFID readout section 23 extracts area information corresponding to the ID information from the area information storage section 40 to identify the area and supplies the area information to the position and posture detection section 24 (step S13).

Thereafter, as in the case of the first embodiment, the position and posture detection section 24 identifies the composite marker 10 captured by the camera of the image input section 21 based on the marker information and area information (step S5); the position and posture detection section 24 detects the position and posture of the camera of the image input section 21 (step S6); and the related information generation section 26 generates related information corresponding to the position and posture of the camera (step S7). Finally, the superimposed image generation section 28 superimposes the image from the image input section 21 and generated related information and displays the superimposed image on a display screen 29A of the display section 29 (step S8).

### Third Embodiment

A third embodiment of the present invention uses the composite marker 10 and information presentation apparatus 20 having the configuration as described in the first embodiment to detect the marker 11, detects ID information from the RFID tag which is the non-contact ID tag 12, and identifies the marker based on the detected ID information.

That is, in the above first embodiment, marker information is acquired based on a plurality of kinds of symbols or designs 11B (such as “50” or “51”) prepared for the marker 11 of the composite marker 10 and, based on the marker information and ID information read out from the non-contact ID tag 12, the marker is identified. In the third embodiment, only one kind (e.g., only “50”) of symbol or design 11B is prepared for every marker 11 of the composite marker 10 irrespective of the area, and unique ID information for identifying the composite marker 10 is stored in the storage section 12C of the non-contact ID tag 12 of each composite marker 10.

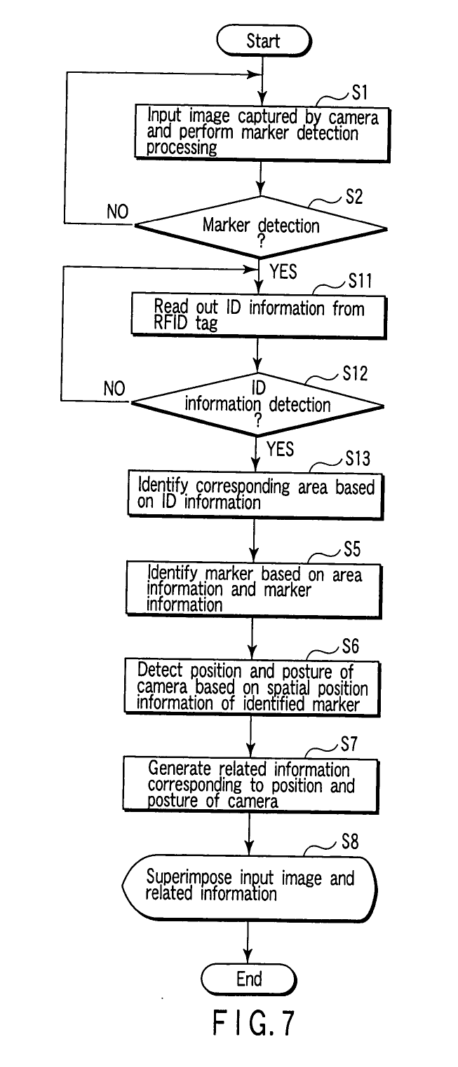

According to the flowchart shown in FIG. 8, the information presentation apparatus 20 serving as a composite marker information acquisition apparatus, which uses such a composite marker 10, firstly uses a camera of the image input section 21 to capture an article 30 to which the composite marker 10 is fixed and inputs the captured image to the marker detection section 22 to thereby detect the marker 11 (step S1), as in the case of the first embodiment.

After the marker 11 has been detected (step S2), the RFID readout section 23 reads out ID information from the non-contact ID tag 12 (step S11). This operation starts when the RFID readout section 23 transmits a data readout instruction on a carrier wave. More specifically, the non-contact ID tag 12 uses a carrier wave received by the antenna 12A to generate required electrical power and, using the generated electrical power, the IC chip 12B reads out information stored in the storage section 12C and transmits the information by means of the antenna 12A. The RFID readout section 23 receives the information transmitted from the non-contact ID tag 12 and determines whether the received information is ID information or not (step S12). When the received information is not ID information, the flow returns to step S11 where the RFID readout section 23 reads out information from the non-contact ID tag 12 once again.

On the other hand, when the received information is ID information, the position and posture detection section 24 identifies the composite marker 10 captured by the camera of the image input section 21 from the read out ID information (step S21).

Thereafter, as in the case of the first embodiment, the position and posture detection section 24 detects the position and posture of the camera of the image input section 21 (step S6) and the related information generation section 26 generates related information corresponding to the position and posture of the camera (step S7). Finally, the superimposed image generation section 28 superimposes the image from the image input section 21 and generated related information and displays the superimposed image on a display screen 29A of the display section 29 (step S8).

It is possible for the position and posture detection section 24 to easily identify the composite marker 10 from the ID information in step S21 by using the ID information that can specify the location area based on known information that has been registered in the marker information storage section 25. For example, the ID information may include position information (latitude, longitude, altitude) in a real world coordinate system.

### Fourth Embodiment

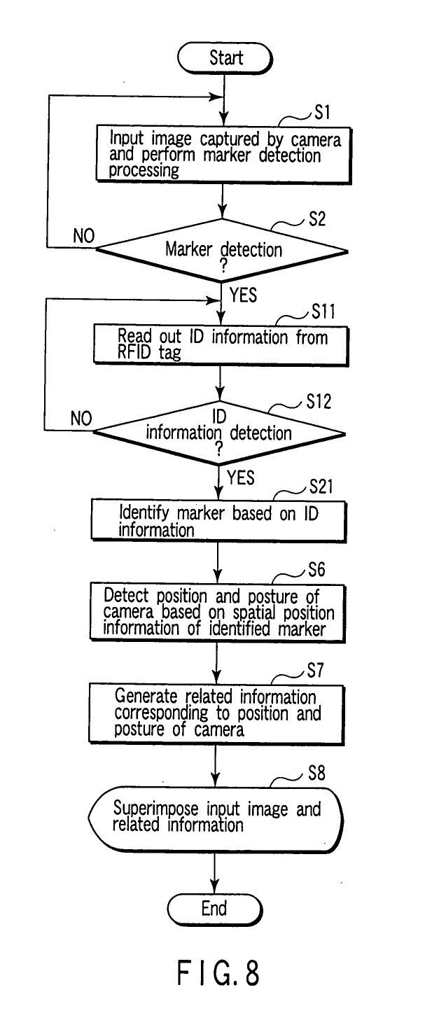

The composite marker 10 according to a fourth embodiment of the present invention has a configuration in which the position of the antenna 12A of the RFID tag which is the non-contact ID tag 12 is offset upward, e.g., to a position outside the frame 11A of the marker 11, as shown in FIG. 9.

In the composite marker 10 according to the first to third embodiments, the antenna 12A is disposed at the center of the composite marker 10 as shown in FIG. 1. In this case, in order to capture the entire image of an article to which the composite marker 10 is fixed, the composite marker 10 needs to be fixed near the center of the article so as to be located at the center of the capturing area 21A. Otherwise, readout of information from the non-contact ID tag 12 cannot be performed reliably. On the other hand, in this fourth embodiment, the position of the antenna 12A is offset upward as described above. In this case, even when the composite marker 10 is fixed to the lower side of the article, the antenna 12A is located at the center of the capturing area 21A at the time of capturing the article. Therefore, readout of information can be performed reliably.

Further, there may be a case where information needs to be presented only to specific persons. In such a case, the composite marker 10 is fixed to the center of the article, and the offset position of the antenna 12A is let known beforehand to specified persons. Persons who are not informed about the offset position of the antenna 12A cannot capture the antenna 12A at the center of the capturing area 21A, so that they cannot read out information from the non-contact ID tag 12.

Although FIG. 9 shows only a case where the antenna 12A is offset upward, the offset direction of the antenna 12A is not limited to the upper direction.

A symbol such as an arrow for indicating a known offset position or direction of the antenna 12A may be displayed on the display screen 29A of the display section 29 in a superimposed manner at the detection time of the marker 11.

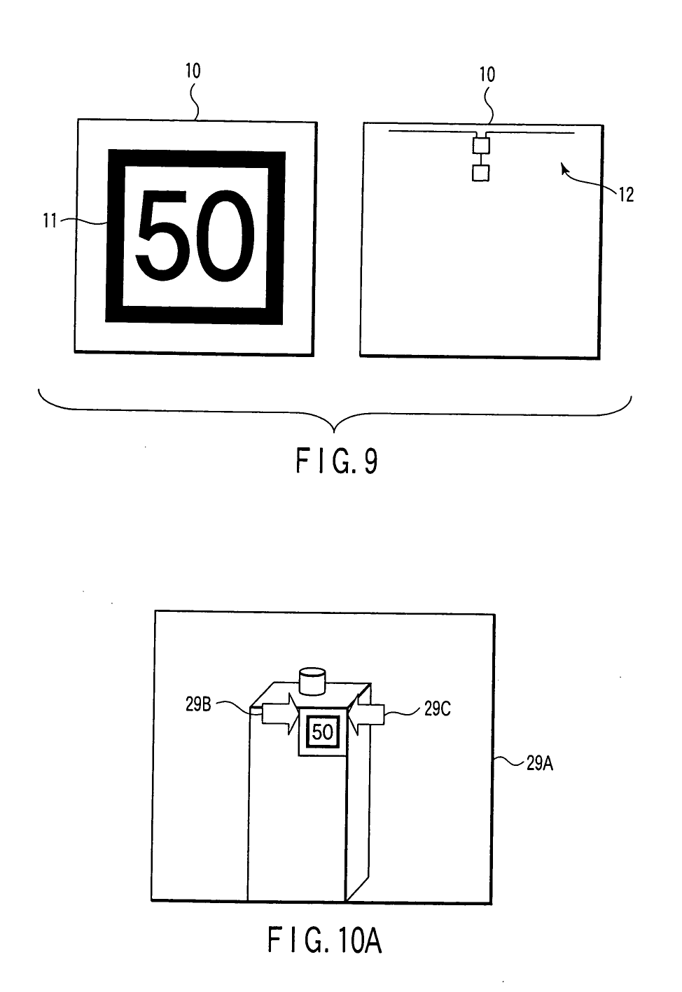

FIGS. 10A to 10C are views each explaining a state where a symbol such as an arrow indicating a known offset position or direction of the antenna 12A is displayed on the display screen 29A of the display section 29 in a superimposed manner at the marker detection time. FIGS. 10A and 10B are views each showing a state where two arrows (29B and 29C), which are used as the symbol for indicating the position of the antenna 12A, are displayed on the display screen 29A of the display section 29 in a superimposed manner. FIG. 10C is a view showing a state where a dashed circle 29D, which is used as a symbol for indicating the position of the antenna 12A, is displayed on the display screen 29A of the display section 29 in a superimposed manner.

If an operator adjusts the relative position between the information presentation apparatus 20 serving as the composite marker information acquisition apparatus and antenna 12A according to the symbol displayed in a superimposed manner, an optimal relative position for information acquisition can be maintained. That is, by using the above symbols, it is possible to guide or direct the image input section 21 through an operator to an optimal position such that the relative position between the composite marker information acquisition apparatus (information presentation apparatus 20) and antenna 12A at the acquisition time of the information from the non-contact ID tag 12 has a more appropriate positional relationship in which a correct information acquisition can be expected.

### Fifth Embodiment

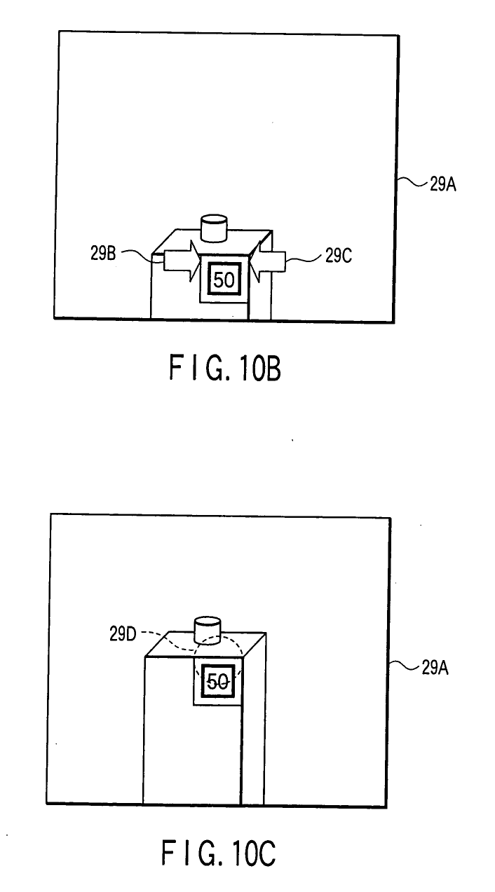

The composite marker 10 according to a fifth embodiment of the present invention shows a case where the position of the antenna 12A of the RFID tag which is the non-contact ID tag 12 is offset upward as in the case of the fourth embodiment, and where a line 13 indicating the position of the antenna 12A is drawn on the surface of the composite marker 10 as shown in FIG. 11.

That is, the readout of information from the non-contact ID tag 12 may fail unless the position of the antenna 12A of the composite marker 10 is previously understood by an operator in the fourth embodiment. In the fifth embodiment, however, the camera of the image input section 21 is directed such that the line 13 indicating the position of the antenna is located at the center of the capturing area, providing a more reliable readout of information from the non-contact ID tag 12.

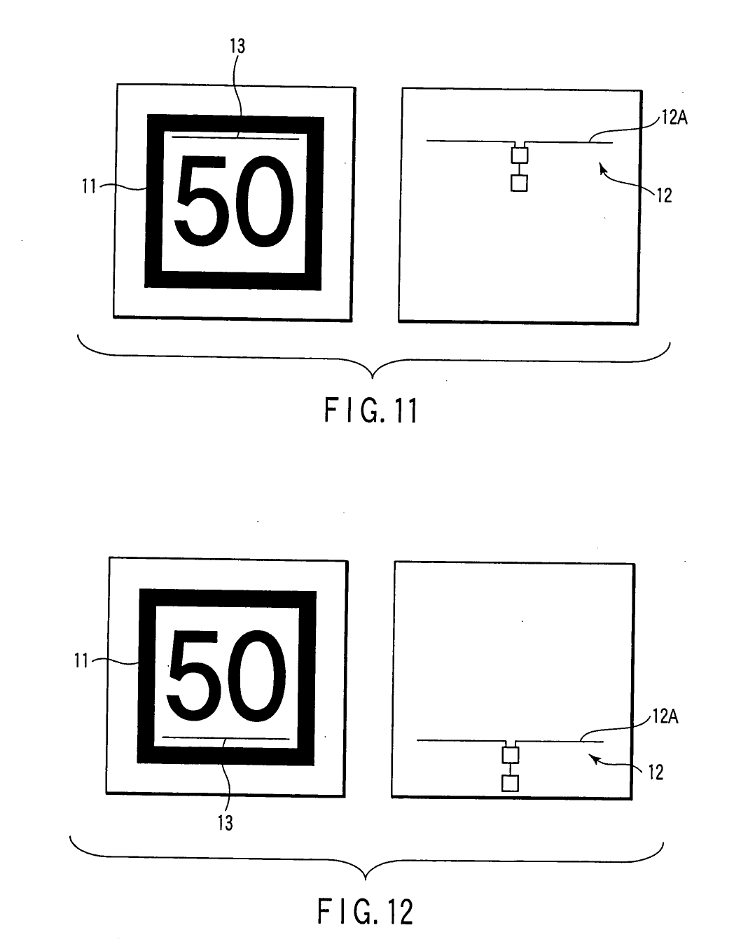

When the position of the antenna 12A of the non-contact ID tag 12 is offset downward, the front and back surfaces of the composite marker 10 are as shown in FIG. 12.

The indication for indicating the position of the antenna is not limited to the line 13. For example, an image such as a 2D barcode may be used as the indication.

Although exemplary embodiments of the present invention have been shown and described, the present invention is not limited to the above embodiments, and various modifications may be made without departing from the scope of the present invention.

For example, as a symbol that represents coded information, an optical marker which has three or more feature points which can optically be distinguished, the 3D arrangement of the feature points being known, and the position and posture of which relative to a camera that captures an image including the feature points thereof can be specified based on the captured image is exemplified. However, any type of marker can be used as long as the 3D position and posture thereof can be specified.

The non-contact ID tag 12 is not limited to the RFID tag, but any type of non-contact tag can be used as long as it can transmit information in a non-contacting manner utilizing, e.g., infrared rays.

Although area information, area ID, or ID information is stored in the storage section 12C of the non-contact ID tag 12 in the above embodiment, information about the symbol or design 11B in the marker 11 of the composite marker 10 may be stored in the storage section 12C. For example, if location information by which the relative position of the symbol or design 11B can be specified is stored in the storage section 12C of the non-contact ID tag 12, the position and posture of the marker 11 can be estimated without the need of storing the position and posture information of the marker in the marker information storage section 25.

As described above, the composite marker 10 is configured to transmit the location information of the marker 11, so that composite markers having the same marker can be distinguished from one another. As a result, it is possible to apparently reduce the number of types of markers to be used, contributing to a reduction of misrecognition.

Further, a required circuit is formed as an IC chip, so that it is possible to reduce the thickness of the composite marker.

Since information about the optical feature of the marker 11 is stored in the storage section 12C, an apparatus for acquiring information from the composite marker can estimate the location of the marker 11 even without known information. In this case, the information stored in the storage section 12C includes the location information by which the relative positions of the optical feature points of the marker can be specified, so that the apparatus for acquiring information from the composite marker can easily specify the relative positions of the optical feature points of the marker 11 based on the location information. If the location information includes positions in the real world coordinate system, the apparatus for acquiring information from the composite marker can directly detect the location of the marker 11.

Alternatively, if the location information to be stored in the storage section 12C includes ID by which the location area can be specified based on known information, the apparatus for acquiring information from the composite marker can easily specify the location area of the composite marker based on the ID and known information.

Since the entire area where the composite marker is located includes a plurality of segmented areas, problems will not occur even if a plurality of markers 11 having the same feature point are used, unless they are located within the same segmented area. In this case, if a plurality of composite markers which can optically be distinguished from one another are located in the same segmented area, it means that there is no composite marker having the marker 11 with the same feature points and therefore it is possible to identify the composite marker 11 reliably. Further, if the location information to be stored in the storage section 12C are made different for each segmented area, it is possible to identify each segmented area based on the location information.

Further, the composite marker 10 transmits specific information of the marker 11 by which each composite marker can be specified among a plurality of composite markers having marker 11 with the same feature points. Therefore, composite markers having the same marker 11 can be distinguished from one other. As a result, it is possible to apparently reduce the number of types of markers to be used, contributing to a reduction of misrecognition.

Further, if the specific information includes positions in the real world coordinate system, the apparatus for acquiring information from the composite marker can specify the composite marker as well as directly detect the location of the composite marker.

Alternatively, the specific information may include IDs by which the location area can be specified based on known information. By doing so, the apparatus for acquiring information from the composite marker can easily specify the composite marker based on the IDs and known information as well as detect the location of the composite marker.

Further, since the marker 11 can be specified by the specific information, problems will not occur even if a plurality of markers 11 having the same feature point are used. This apparently reduces the number of types of the markers.

In the composite marker, the antenna 12A is fixed to a predetermined position relative to the marker 11. That is, the position of the antenna 12A is determined relative to the marker 11. Therefore, it is possible to easily set the information acquisition apparatus to a predetermined position relative to the marker 11 to thereby read out information about the marker 11 and the non-contact ID tag 12 more reliably.

In this case, the antenna 12A is located within the marker area of the marker 11. Therefore, if the information acquisition apparatus is set to a position such that the capturing area of the apparatus encompasses the marker 11, the apparatus can reliably receive information transmitted from the antenna 12A.

If the antenna 12A is displaced outside the marker area of the marker 11, it is possible to allow only specific persons who know the position of the antenna 12A to read out the information of the marker 11.

Further, by providing the line 13 indicating the position of the antenna 12A on the marker 11 as coded information by which the relative position of the antenna 12A can be specified, it is possible to set the information acquisition apparatus to a position where it can reliably read out the information of the marker 11 according to the line 13.

Further, it is possible to determine whether the information of the marker 11 can be read out or not simply based on the captured image of the marker 11. This prevents the information acquisition apparatus from performing unnecessary readout operation in the case where the apparatus is set to a position where the antenna 12A falls outside the capturing area.

The RFID readout section 23 performs information acquisition based on the image that the image input section 21 having a predetermined capturing area 21A has captured. Thus, the composite marker information acquisition apparatus can read out the information of the marker 11 (symbol containing coded information) and non-contact ID tag 12 at an appropriate timing.

If even a part of the information acquisition area 23A (non-contact ID tag readout area) exists within the capturing area 21A, information can be acquired from the non-contact ID tag 12. In this case, if the capturing area 21A completely encompasses the information acquisition area 23A, the information can be acquired more reliably from the non-contact ID tag 12.

The marker detection section 22 detects that the marker 11 enters the capturing area 21A, so that it is possible to easily determine the timing at which the RFID readout section 23 performs information acquisition operation.

The RFID readout section 23 processes the image being captured by the image input section 21 and starts performing the information acquisition operation when it is estimated that the input image section 21 has reached a predetermined position and posture relative to the marker. Therefore, it is possible to determine an appropriate timing at which the information can reliably be acquired. In this case, the predetermined position and posture are generally set to a position and posture assumed when the image input section 21 fully faces the marker. Alternatively, the predetermined position and posture are set to a position and posture assumed when the image input section 21 fully faces the antenna 12A of the non-contact ID tag 12.

The marker detection section 22 displays an indication indicating the position and/or direction on the display section 29 so that the image input section 21 is easily guided to the predetermined position and posture. Therefore, it is possible to guide or direct the image input section 21 through an operator to an optimal position such that the relative position between the information acquisition apparatus and marker has a more appropriate positional relationship in which a correct information acquisition can be expected.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A composite marker including an optical marker section having at least three feature points obtained by one of symbol and design containing a character which can optically be distinguished, the 3D arrangement of the feature points being known, comprising:
a storage section configured to store location information of the optical marker section by which the area where the optical marker section is located can be specified; and
a transmission section configured to transmit the location information of the optical marker section stored in the storage section in a non-contacting manner,
the optical marker section, storage section, and transmission section being formed integrally.

2. The composite marker according to claim 1, wherein the transmission section includes an antenna and an IC chip.

3. The composite marker according to claim 1, wherein the storage section is configured to store information related to the optical feature of the optical marker section.

4. The composite marker according to claim 3, wherein the information stored in the storage section includes the location information by which the relative position of the optical feature of the optical marker section can be specified.

5. The composite marker according to claim 1, wherein the location information stored in the storage section includes a position in the real world coordinate system.

6. The composite marker according to claim 1, wherein the location information stored in the storage section includes an ID by which the location area of the optical marker section can be specified based on known information.

7. The composite marker according to claim 1, wherein the entire area where the composite marker is located is divided into a plurality of segmented areas.

8. The composite marker according to claim 7, wherein in each of the segmented area, a plurality of optically-distinguishable composite markers are located.

9. The composite marker according to claim 7, wherein the location information stored in the storage section are different from one another for each segmented area.

10. A composite marker including an optical marker section having at least three feature points obtained by one of symbol and design containing a character which can optically be distinguished, the 3D arrangement of the feature points being known, comprising:
a storage section configured to store specific information of the optical marker section by which each composite marker can be specified among a plurality of composite markers having the optical marker sections with the same feature points; and
a transmission section configured to transmit the specific information of the optical marker section stored in the storage section in a non-contacting manner,
the optical marker section, storage section, and transmission section being formed integrally.

11. The composite marker according to claim 10, wherein the transmission section includes an antenna and an IC chip.

12. The composite marker according to claim 10, wherein the specific information stored in the storage section includes a position in the real world coordinate system.

13. The composite marker according to claim 10, wherein the specific information stored in the storage section includes an ID by which the location area of the optical marker section can be specified based on known information.

14. The composite marker according to claim 10, wherein the area where the composite marker is located includes a plurality of composite markers having the same optical marker section.

15. A composite marker which is targeted by an information acquisition apparatus including a camera having a predetermined capturing area, and a non-contact ID information acquisition section which acquires information retained by a non-contact ID tag set in a predetermined position relative to the capturing area, the composite marker comprising:
an optical maker section having at least three feature points obtained by one of symbol and design containing a character which can optically be distinguished, the 3D arrangement of the feature points being known, and the position and posture of which relative to the camera that captures an image including the feature points thereof can be specified based on the captured image; and
a non-contact ID tag including a storage section configured to retain information related to one of the optical marker section and an article to which the optical marker section is fixed and a transmission section configured to transmit information retained by the storage section in a non-contacting manner,
the transmission section including an antenna section fixed to a predetermined position relative to the optical marker section.

16. The composite marker according to claim 15, wherein the antenna section is located within the marker area of the optical marker section.

17. The composite marker according to claim 15, wherein the antenna section is displaced outside the marker area of the optical marker section.

18. The composite marker according to claim 15, wherein the optical marker section contains coded information by which the relative position of the antenna section can be specified.

19. The composite marker according to claim 15, wherein the information acquisition apparatus can determine that the apparatus is located at a position where the apparatus can read out information based on a captured image of the optical marker section.

20. A composite marker information acquisition apparatus comprising:
an image capture section having a predetermined capturing area and configured to capture a marker which has an optical feature and which is fixed to an object located within the capturing area;
an information acquisition section configured to acquire information related to one of the marker and object fixed to the marker from a non-contact ID tag whose position is fixed relative to the marker and which retains the information related to one of the marker and object; and
an information acquisition control section configured to allow the information acquisition section to perform information acquisition based on an image captured by the image capture section.

21. The composite marker information acquisition apparatus according to claim 20, wherein the information acquisition area exists within the capturing area of the image capture section.

22. The composite marker information acquisition apparatus according to claim 21, wherein the capturing area includes the information acquisition area.

23. The composite marker information acquisition apparatus according to claim 20, wherein the information acquisition control section is configured to allow the information acquisition section to perform information acquisition at the time when the marker enters the predetermined capturing area of the image capture section.

24. The composite marker information acquisition apparatus according to claim 20, wherein the information acquisition section is configured to perform information acquisition when an image captured by the image capture section is processed and it is estimated that the image capture section has reached a predetermined position and posture relative to the marker.

25. The composite marker information acquisition apparatus according to claim 24, wherein the predetermined position and posture are generally set to a position and posture assumed when the image capture section fully faces the marker.

26. The composite marker information acquisition apparatus according to claim 24, wherein the predetermined position and posture are set to a position and posture assumed when the image capture section fully faces an antenna of the non-contact ID tag.

27. The composite marker information acquisition apparatus according to claim 24, further comprising a display section,
the information acquisition control section being configured to display an indication indicating at least one of the position and direction on the display section so that the image capture section is easily guided to the predetermined position and posture.
